(19) United States
(12) Patent Application Publication
(10) Pub. No.: US 2017/0004451 A1
(43) Pub. Date: Jan. 5, 2017

(54) RECRUITER-INITATED EMPLOYMENT REFERRALS LEVERAGING MEMBER CONNECTIONS

(71) Applicant: Linkedln Corporation, Mountain View, CA (US)

(72) Inventors: Prasad Kamalakar Gune, Fremont, CA (US); Qi Liu, Saratoga, CA (US)

(21) Appl. No.: 14/788,264

(22) Filed: Jun. 30, 2015

(51) Int. Cl. G06Q 10/10; G06Q 50/00

(52) U.S. Cl. CPC G06Q 10/1053; G06Q 50/01

(57) ABSTRACT

Techniques for facilitating a recruiter-initiated referral of a member of a social networking service are described. Data is received corresponding to a selection of a profile of a candidate desired by a recruiter to apply for an open job having a job posting on the social networking service. A set of member profiles connected to the candidate's profile are presented. Data is received corresponding to a selection of a connected member profile from the set. The selected member is presented with a message requesting whether the selected member would refer the candidate for the open job. If the selected member answers affirmatively, the candidate is sent a message inviting the candidate to apply for the open job.

### TECHNICAL FIELD

The present disclosure relates generally to online social networking services and specifically to facilitating recruiter-initiated referrals of members of an online social networking service.

### BACKGROUND

An online social networking service is a computer- or web-based application that enables users to establish links or connections with other people to share information with one another. Some online social networking services aim to enable friends and family to communicate and share information with one another, while others are specifically directed to business users with a goal of facilitating the establishment of professional relationships and the sharing of business information. As used herein, the terms “social network,” “social networking service,” “online social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks”).

### BRIEF DESCRIPTION OF THE DRAWINGS

Some embodiments are illustrated by way of example and not limitation in the figures of the accompanying drawings.

FIG. 1 is a block diagram illustrating various components of an online social networking service with an employment referrals module for facilitating employment referrals of members, according to an embodiment.

FIG. 2 illustrates an example of a user interface for using various criteria to search for one or more members of an online social networking service, according to an embodiment.

FIG. 3 illustrates filtering the search results portion of the user interface based on a selected result summary, according to an embodiment.

FIG. 4 illustrates the user interface displaying additional information based on a selected information label of a candidate profile, according to an embodiment.

FIG. 5 illustrates a referral request dialog presented to an employment recruiter, according to an embodiment.

FIG. 6 illustrates a referral request received by a selected company connection from an employment recruiter, according to an embodiment.

FIG. 7 illustrates a job application invitation received by a selected candidate, according to an embodiment.

FIG. 8 is a flow diagram illustrating a method performed by a user (e.g., an employment recruiter) to initiate a referral of a selected candidate to a job posting by leveraging a member connection of the selected candidate, according to an embodiment.

FIG. 9 is a flow diagram illustrating a method performed by an interface for an online social networking service that facilitates recruiter-initiated employment referrals leveraging member connections, according to an embodiment.

FIG. 10 is a block diagram illustrating an example of a machine, upon which any one or more example embodiments may be implemented.

### DETAILED DESCRIPTION

The present disclosure describes methods, systems, and computer program products that individually facilitate employment referrals of online social network members to job postings on the online social network. A referral may be recruiter-initiated or employee-initiated.

With some online social networks, members are prompted to provide a variety of personal information, which may be displayed in a member's personal web page. Such information is commonly referred to as “personal profile information”, or simply “profile information”, and when shown collectively, it is commonly referred to as a member's profile. For example, with some of the many existing online social networks, the personal information that is commonly requested and displayed as part of a member's profile includes a member's age (e.g., birth date), gender, contact information, home town, address, the name of the member's spouse and/or family members, a photograph of the member, interests, and so forth. With some online social networks, such as some business network services, a member's personal information may include information commonly included in a professional resume or curriculum vitae, such as information about a person's education, employment history, job skills, professional organizations, and so forth. Each instance of this personal information on a member's profile may be referred to as a “feature.”

Members of an online social network may be people or organizations (e.g., corporations, partnerships, non-profit organizations, etc.) Organizations may create profiles that may be visible to other members and may contain information about the organization (e.g., news, messages, other communications from the organization, etc.) Members may follow or connect with these organizations in the same way as they do other members. These organizational pages feature information about the organization and can serve as a powerful recruiting, marketing, or sales tool. Using the online social network, an organization may recruit talent, generate interest in products, deliver news, and engage in other forms of advertising and marketing.

An online social network may allow its members to identify, and establish links or connections with other members. For instance, in the context of a business networking service (a type of online social network), a member may establish a link or connection with his or her business contacts, including work colleagues, clients, customers, personal contacts, and so on. With an online social network, a member may establish links or connections with his or her friends, family, or business contacts. Although an online social networking service and a business networking service may be generally described in terms of typical use cases (e.g., for personal and business networking respectively), it will be understood by one of ordinary skill in the art with the benefit of Applicant's disclosure that a business networking service may be used for personal purposes (e.g., connecting with friends, classmates, former classmates, and the like) as well as, or instead of, business networking purposes; and an online social networking service may likewise be used for business networking purposes as well as or in place of social networking purposes. A connection may be formed using an invitation process in which one member “invites” a second member to form a link. The second member then has the option of accepting or declining the invitation.

Online social networks provide a rich source of information about their members. Thus, employment recruiters are increasingly using online social networks to recruit candidates into open positions. A recruiter may find a candidate by searching or browsing member profiles that exhibit various desired characteristics. For example, a recruiter may search for members who have profiles indicating the possession of requisite skills and qualifications, such as certain technical skills, educational/professional experiences, and backgrounds. Upon finding a potential candidate for an open job, the recruiter may contact, using the online social network, the potential candidate to attempt to recruit the potential candidate into the open job. However, the potential candidate may not be receptive to such “cold call” recruiting. A more effective recruiting technique may be to enlist a member that is connected on the online social network to the potential candidate to contact the potential candidate to inquire whether the potential candidate is interested in the open job.

Some online social networking services allow members of the community to write a testimonial or “recommendation” of certain people in their network of contacts. For example, a user, Jane, may know that one of her contacts, Bob, is looking for a job. Since Jane has previously worked with Bob and knows him to be an excellent market research analyst as well as a hard worker and easy to get along with, she writes a recommendation for Bob; upon approval of the recommendation from Bob, Jane's recommendation is included as part of Bob's electronic profile. When a potential employer searches the online social networking service and comes across Bob's online profile, the employer can see Jane's recommendation of Bob in Bob's profile.

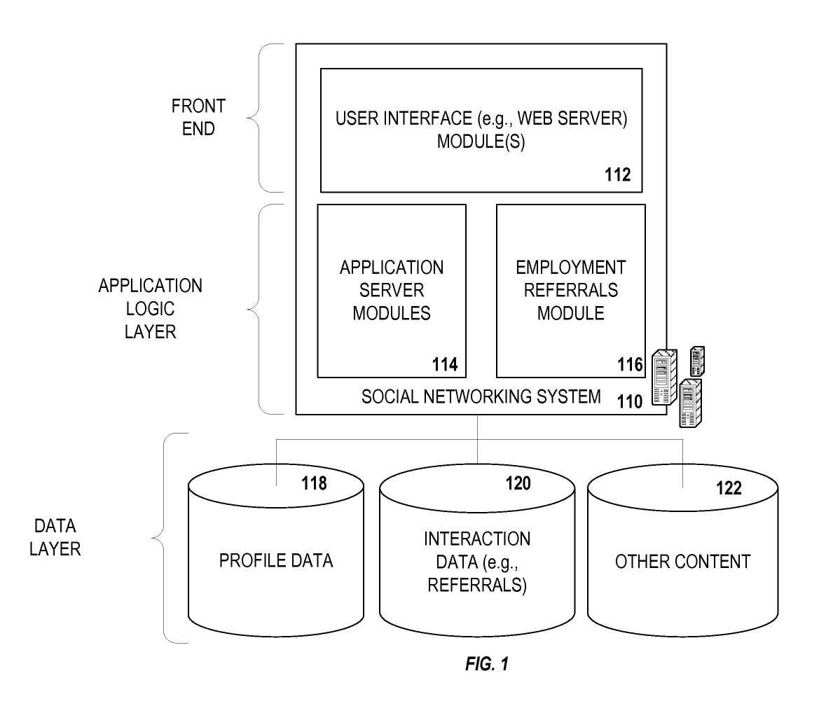

FIG. 1 is a block diagram illustrating various components of an online social networking service 110 with an employment referrals module 116 for facilitating employment referrals of members, according to an embodiment. As shown in FIG. 1, the online social networking service 110 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the disclosure with unnecessary detail, various functional modules and engines that are not germane to conveying an understanding of the disclosed subject matter have been omitted from FIG. 1. However, a skilled artisan will readily recognize that various additional functional modules and engines may be used with an online social networking service 110 such as that illustrated in FIG. 1, to facilitate additional functionality that is not specifically described herein. Furthermore, in an embodiment, the various functional modules and engines depicted in FIG. 1 reside on a single server computer; in another embodiment, the various functional modules and engines depicted in FIG. 1 are distributed across several server computers in various arrangements.

As shown in FIG. 1, the front end consists of a user interface module (e.g., a web server) 112, which receives requests from various client computing devices (not shown), and communicates appropriate responses to the requesting client computing devices. In an embodiment, the user interface module(s) 112 receive requests in the form of Hypertext Transport Protocol (HTTP) requests, or other web-based, application programming interface (API) requests. The application logic layer includes various application server modules 114, which, in conjunction with the user interface module(s) 112, generates various user interfaces (e.g., web pages) with data retrieved from various data sources in the data layer. In an embodiment, individual application server modules 114 are used to implement the functionality associated with various services and features of the online social networking service. For example, the ability to infer or estimate a professional reputation for a member of the online social networking service—is a service implemented in an independent application server module 114. Similarly, other applications or services that utilize the employee referrals module 116 will be embodied in their own application server modules 114.

As shown in FIG. 1, the data layer includes several databases, such as a database 118 for storing profile data (e.g., member profile data), database 120 for storing interaction data (e.g., employment referrals), and database 122 for storing other content (e.g., job listings, interest groups, companies, advertisements, events, news, discussions, tweets, questions and answers, etc.)

When a person initially registers to become a member of the online social networking service, the person is prompted to provide some personal information, such as his or her name, age (e.g., birthdate), gender, interests, contact information, home town, address, the names of the member's spouse and/or family members, educational background (e.g., schools, majors, etc.), employment history, skills, professional organizations, and so on. This information is stored, for example, in profile database 118.

Once registered, a member may invite other members, or be invited by other members, to connect via the online social networking service. A “connection” may require a bi-lateral agreement by the members, such that both members acknowledge the establishment of the connection. Similarly, a member may elect to “follow” another member. In contrast to establishing a “connection,” the concept of “following” another member typically is a unilateral operation, and in an embodiment, does not require acknowledgement or approval by the member that is to be followed. In an embodiment, when one member follows another, the member who is following receives automatic notifications about various activities undertaken by the member being followed.

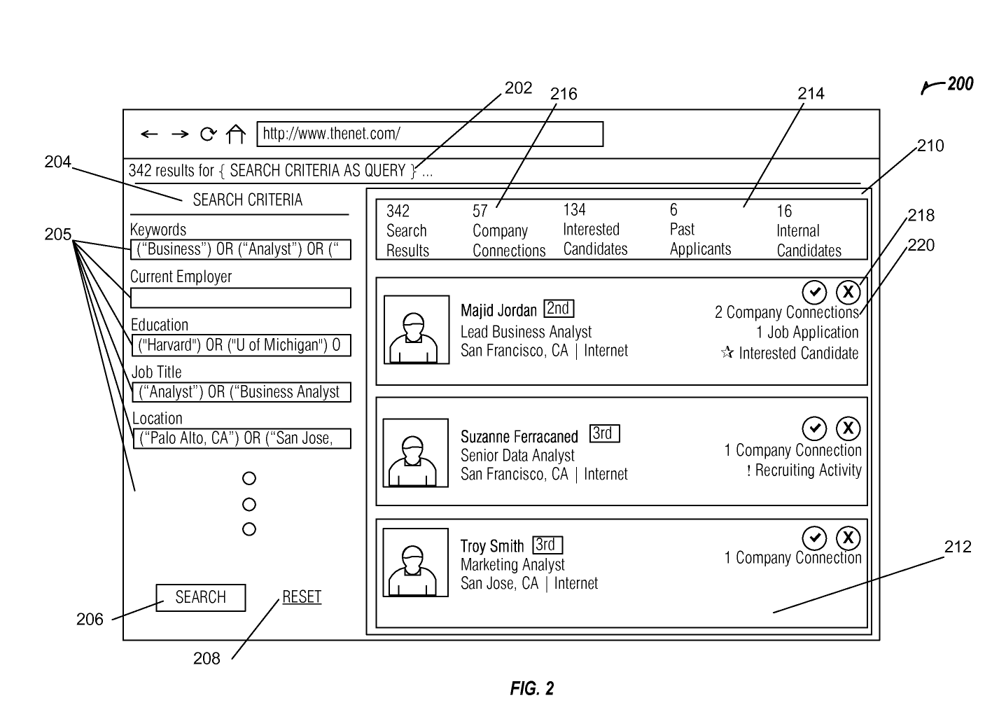

FIG. 2 illustrates an example of a user interface 200 for using various criteria to search for one or more members of an online social networking service, according to an embodiment. A user (e.g., a recruiter or an employee) may use various methods to find potential candidates for employment referrals. For example, a user may use a search interface specifically designed for searching for members who fit particular criteria. One such example search interface is illustrated in FIG. 2.

Prior to searching for members, the user may select a job posting on the online social networking service. A job posting typically includes the name of the company or organization at which the job opening is available, the title for the job, a description of the job functions, the required or recommended skills, education, and certifications and/or expertise, etc.

As illustrated in FIG. 2, a user interface 200 may be presented to the user. The user interface 200 may include an editable query to identify member profiles of potential referral candidates. The editable query may be displayed as a compound statement 202 of its clauses. Each relevant profile feature of the editable query may be presented in the Search Criteria portion 204 of the user interface 200 as a clause in a textbox 205 corresponding to its profile feature type. A user may be able to edit, modify, or update the clauses 205 of the editable query.

A user may be able to select a user interface element to cause the contents of the clause textboxes 205 to be combined into a new query, and for the query to be executed on the data of the online social networking service; this user interface element may be a search button 206 or a search hyperlink. The results of the query execution are then displayed in the search results portion 210 of the user interface 200.

The Search Criteria portion 204 of the user interface may include a reset hyperlink 208 or reset button which, when selected, causes the clause textboxes 205 to be reset. Selecting the reset hyperlink 208 may cause the text in the clause textboxes 205 to be deleted, or may cause the text in the clause textboxes 205 to be set to the most recent query that resulted in the list of candidate profiles 212 that were displayed in the search results portion 210 of the user interface 200.

The search results portion 210 of the user interface 200 may include a list of candidate profiles 212 that have been determined to satisfy the search criteria. A candidate profile 212 in the candidate profile list may be an abbreviated member profile (e.g., the candidate profile 212 includes a subset of the profile features of the candidate's corresponding member profile). For example, a candidate profile 212 may include the candidate's name, member profile image, current job title, current job location, industry of the current job, etc.

A candidate profile 212 may include a “connection degree indicator.” In an example, the searching user and the member represented by the candidate profile 212 may be connected by a first-degree connection (e.g., the searching user and the member exchanged an invitation to be connected and an acceptance of the invitation). In another example, the searching user and the member represented by the candidate profile 212 may be connected by an indirect connection. An example of an indirect connection is a second-degree connection where the searching user and the member represented by the candidate profile 212 share a first-degree connection. Other degrees of connection may also be included, such as third-degree connections, fourth-degree connections, and so forth. A candidate profile 212 may include a connection degree indicator to indicate the relative degree of connection between the searching user and the member represented by the candidate profile 212.

The list of candidate profiles 212 may be unordered, or may be ordered in various ways. For example, as illustrated in FIG. 2, the list of candidate profiles 212 may be listed in descending order of connection degree to the searching user or the hiring organization.

A candidate profile 212 may include one or more contact management controls 218. For example, one contact management control 218 (e.g., a checkmark within a circle) may allow the user to mark the candidate as a possible candidate for the selected job posting, and may save the candidate profile in a “possible candidate” list. Another contact management control 218 (e.g. an “X” within a circle) may allow the user to mark the candidate as not a candidate for the selected job posting, and may remove the candidate from results of future candidate searches for the selected job.

In addition to the list of candidate profiles 212, the search results portion 210 of user interface 200 may include an “intelligent sourcing strip” 214, which provides one or more result summaries 216 regarding the list of candidate profiles 212. Each result summary 216, which includes a number and a label descriptive of the summary, displays a particular characteristic for the list of candidate profiles 212. For example, the intelligent sourcing strip 214 of FIG. 2 informs the user that the search results (i.e., the list of candidate profiles 212) includes 342 search results (i.e., candidate profiles), 57 “Company Connections,” 134 “Interested Candidates,” 6 “Past Applicants,” and 16 “Internal Candidates.” Selecting a particular result summary 216 causes the search results portion 210 of user interface 200 to filter the list of candidate profiles 212 to display only those candidate profiles 212 that are described by the selected result summary 216. For example, selecting “6 Past Applicants” within FIG. 2 would cause the displayed candidate profile list 212 to contain only those candidate profiles 212 whose member has previously applied for the selected job.

A candidate profile 212 may include one or more information labels 220. An information label 220 within a candidate profile 212 displays information related to the member represented by candidate profile 212. Examples of information labels 220 include: the number of employees of an organization related to either the searching user or the selected job to which the member represented by candidate profile 212 is connected (“company connections”), the number of times the member represented by candidate profile 212 has applied for either the selected job or another job within the organization of the selected job (“job applications”), an indication whether the member represented by candidate profile 212 is interested in either the selected job or in changing jobs (“interested candidate”), the number of members profiles to which both the member profile of the searching user and the member profile of the member represented by candidate profile 212 are connected (“shared connections”), an indication whether the member represented by candidate profile 212 has engaged in or has been an intended recipient of recruitment activity for either the selected job or another job with the organization of the selected job (“recruiting activity”), etc.

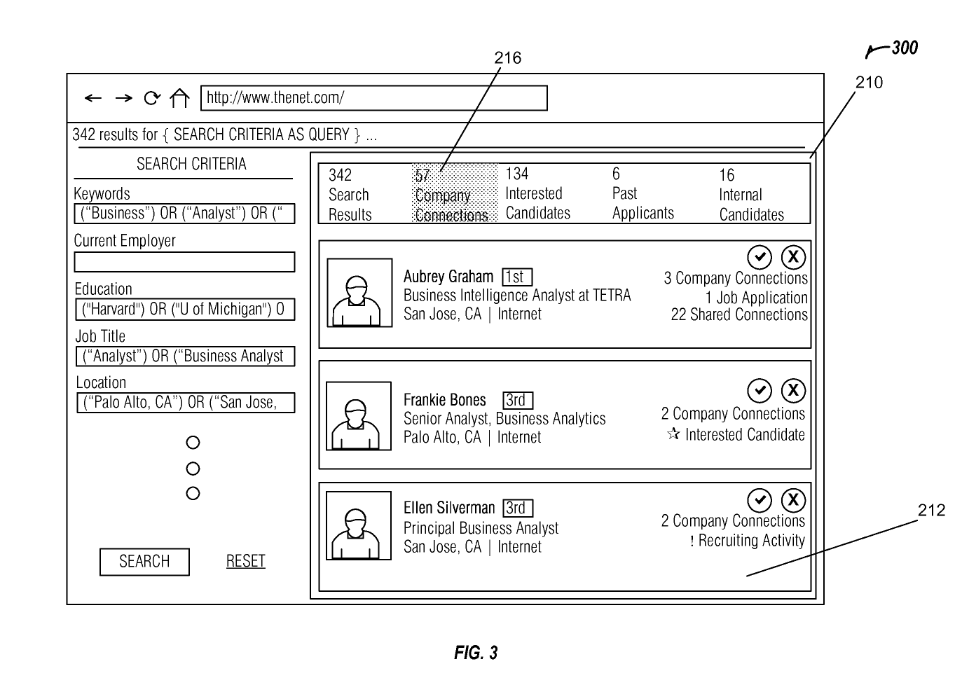

FIG. 3 illustrates filtering the search results portion 210 of the user interface 200 based on a selected result summary 216, according to an embodiment. Selecting a particular result summary 216 causes the search results portion 210 of user interface 200 to filter the list of candidate profiles 216 to display only those candidate profiles 212 that are described by the selected result summary 216. For example, as illustrated in FIG. 3, the selection of the result summary 302 labelled “57 Company Connections” causes the list of candidate profiles 212 to be filtered to include only those candidate profiles 212 whose member has a member profile that is connected to a member profile of an employee of the organization of the selected job.

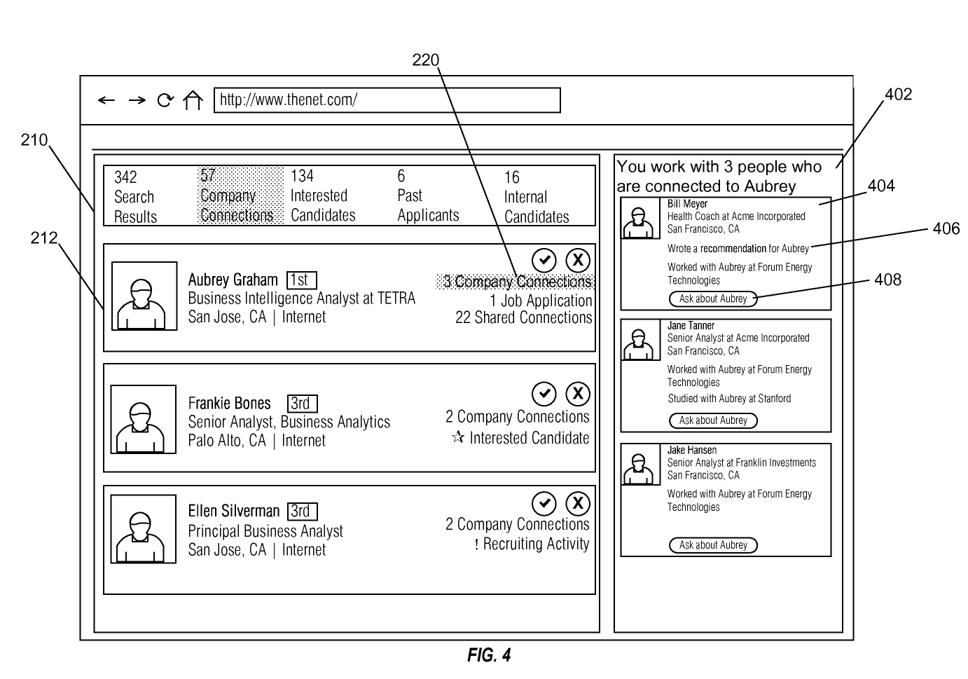

FIG. 4 illustrates the user interface 200 displaying additional information based on a selected information label 220 of a candidate profile 212, according to an embodiment. An information label 220 of a candidate profile 212 may be selectable. Upon selection of such an information label 220, the Search Criteria portion 204 of the user interface 200 may be hidden and a candidate detail portion 402 of the user interface 200 may be displayed. Additional information related to the selected information label 220 may be presented in the candidate detail portion 402. For example, if a “job application” information label 220 of a candidate profile 212 was selected, the candidate detail portion 402 may display information for or a link to the related job posting or application for the candidate profile 212. As another example, if a “shared connection” information label 220 of a candidate profile 212 was selected, the candidate detail portion 402 may display a profile for the shared connection.

As illustrated in FIG. 4, the selection of the “3 Company Connections” information label 220 of the candidate profile 212 for “Aubrey Graham” causes the candidate detail portion 402 of the user interface 200 to display a list of three company connection profiles 404 related to candidate Aubrey Graham. Each company connection profile 404 in the list may be an abbreviated member profile (e.g., the company connection profile 404 includes a subset of the profile features of the company connection's corresponding member profile). For example, a company connection profile 404 for a member may include the member's name, profile image, current job title, current job location, industry of the current job, etc.

The list of connection profiles 404 may be unordered, or may be ordered in various ways. For example, as illustrated in FIG. 4, the list of connection profiles 404 may be listed in descending order of “relationship strength” to the searching user. A strength of a relationship between two members may vary based on various factors, such as the amount of time the members have been connected, the endorsements or recommendations by one member for the other member (and vice versa), the amount of time the members worked together, the number of different organizations at which the members worked together, etc.

A company connection profile 404 for a member may include one or more relationship statements 406. A relationship statement 406 within a company connection profile 404 describes a specific relationship between the member represented by company connection profile 404 and the candidate profile. For example, as illustrated in FIG. 4, the company connection profile 404 for “Bill Meyer” has two relationship statements 406: one that states Bill Meyer wrote a recommendation for Aubrey, and another that states Bill Meyer worked with Aubrey at Forum Energy Technologies. A relationship statement 406 within a company connection profile 404 may be selectable; selecting such a relationship statement 406 may cause additional information about the relationship to appear. For example, clicking on a relationship statement 406 for a recommendation may cause the recommendation to be displayed.

A company connection profile 404 for a member may include a selectable user interface element, such as a referral request button 408. Upon the user selecting referral request button 408, a referral request dialog may be presented to the user.

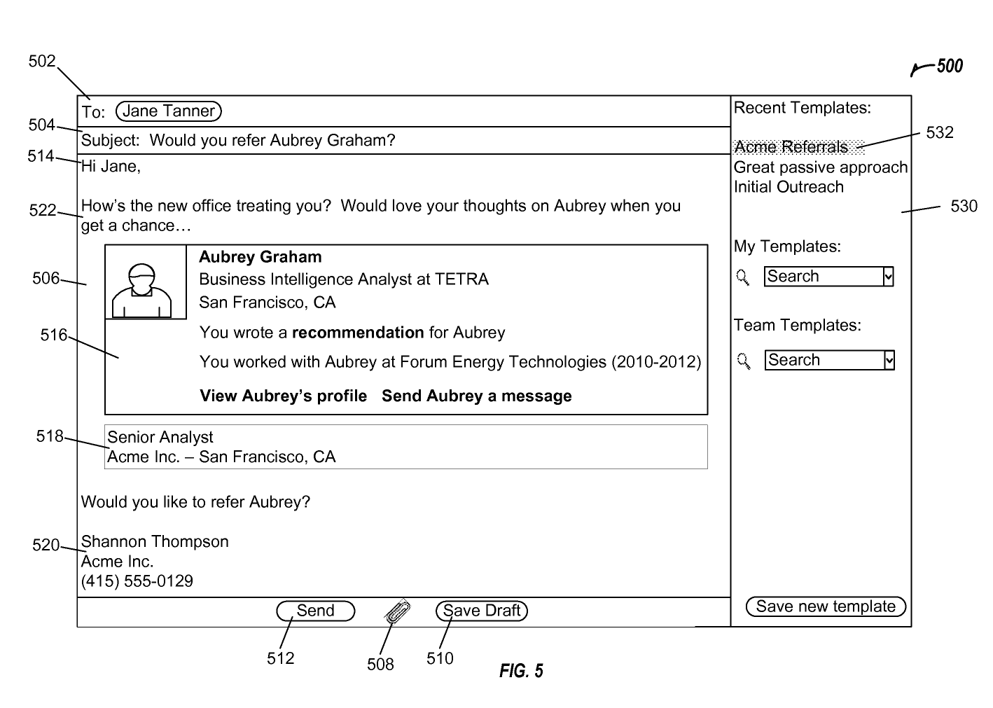

FIG. 5 illustrates a referral request dialog 500 presented to an employment recruiter, according to an embodiment. The referral request dialog 500 may appear similar to a composition dialog for composing an email message. For example, the referral request dialog 500 may include a “To” field 502 for entering an identifier of a recipient of the referral request, a “Subject” field 504 for entering text describing the subject of the referral request, a “Body” field 506 for entering the contents of the referral request, an attachment mechanism 508 for attaching a file to the referral request, a “Save” button 510 for saving a draft of the referral request, and a “Send” button 512 for sending the referral request to the identified recipient(s).

Upon being displayed, one or more fields of the referral request dialog 500 may be blank or may be prepopulated appropriately. For example, as illustrated in FIG. 5, the user caused the referral request dialog 500 to be displayed by selecting the referral request button 408 of the company connection profile 404 for member Jane Tanner; thus, the “To” field 502 of the referral request dialog 500 is prepopulated with an identifier for Jane Tanner, the “Subject” field 504 of the referral request dialog 500 includes “Aubrey Graham” as the name of the candidate that is the target of the referral, the greeting portion 514 of the “Body” field 506 includes Jane's first name, and the “Body” field 506 includes a modified member profile 516 for the selected candidate, a link 518 to the selected job posting, and the user's contact information 520 (“Shannon Thompson, Acme Inc., (415) 555-0129”).

The modified member profile 516 for the selected candidate may be similar to the company connection profile 404 for the selected company connection; however, the contents of the modified member profile 516 are from the perspective of the selected company connection to the selected candidate. For example, as illustrated in FIG. 5, the modified member profile 516 is for the selected candidate “Aubrey Graham,” and the relationship statements in the modified member profile 516 are from the perspective of the selected company connection “Jane Tanner.” The modified member profile 516 may include a link to view the profile of the selected candidate or to send the selected candidate a message. The modified member profile 516 may serve to remind the selected company connection of the selected candidate or of how the selected candidate is related to the selected company connection.

One or more fields of the referral request dialog 500 may be prepopulated based on a saved template, which can specify how one or more fields of the referral request dialog 500 should be prepopulated. As illustrated in FIG. 5, a portion 530 of the referral request dialog 500 may be devoted to templates for the referral request dialog 500. The templates portion 530 of the referral request dialog 500 may allow the user to select a template to use for the current referral request, select a template to use for future referral requests, search for templates, save a new template based on the contents of the current referral request dialog, delete templates, etc.

The user may customize the referral request by modifying the contents of the fields within the referral request dialog 500. For example, the user may add a personal note 522 to the “Body” field 506 (e.g., “How's the new office treating you? Would love your thoughts on Aubrey when you get a chance . . . ” and “Would you like to refer Aubrey?”), may attach one or more files, etc.

Upon selecting the “send” button 512, the referral request is sent to each recipient identified in the “To” field 502. If the identifier for a recipient is an email address, the referral request is sent as an email to the recipient's email address; if the identifier for a recipient is an account of the recipient on the online social networking service, the referral request is sent as a message to the identified account of the recipient on the online social networking service.

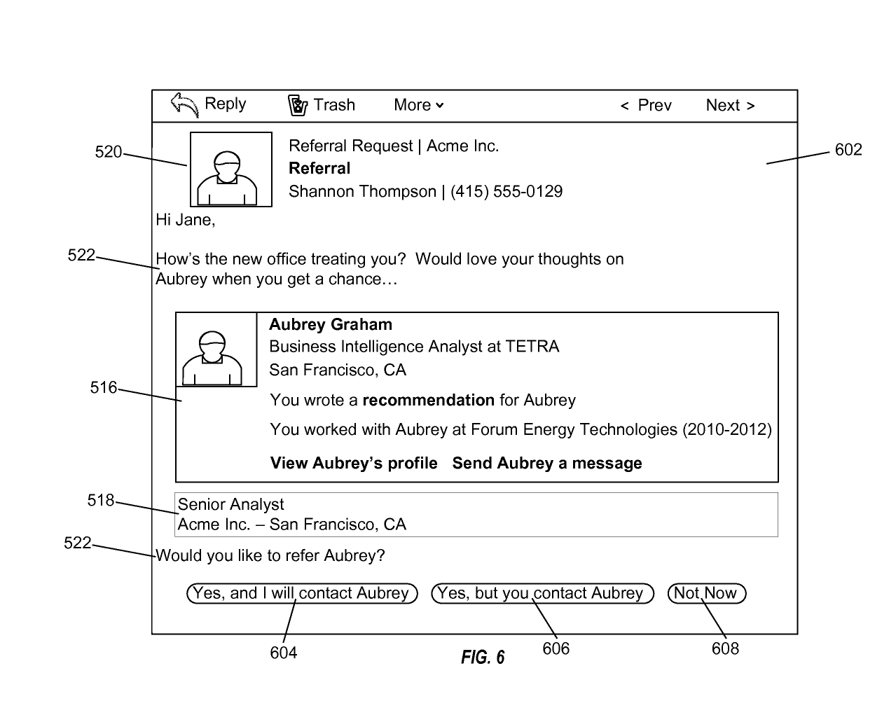

FIG. 6 illustrates a referral request 602 received by a selected company connection from an employment recruiter, according to an embodiment. The referral request 602 may include some or all of the contents submitted via the referral request dialog 500, for example: the modified member profile 516 for the selected candidate, the link 518 to the selected job posting, and the user's contact information 520 (“Shannon Thompson, Acme Inc., (415) 555-0129”), as well as the personal note(s) 522.

The received referral request 602 may include several options for the selected company connection to respond to the referral request 602. The received referral request 602 may contain three selectable controls corresponding to the responses, “Yes, and I will contact (the selected candidate),” “Yes, but you contact (the selected candidate),” and “Not Now.” For example, as illustrated in FIG. 6, the received referral request 602 contains three buttons 604, 606, 608, corresponding to the responses, “Yes, and I will contact Aubrey,” “Yes, but you contact Aubrey,” and “Not Now,” respectively.

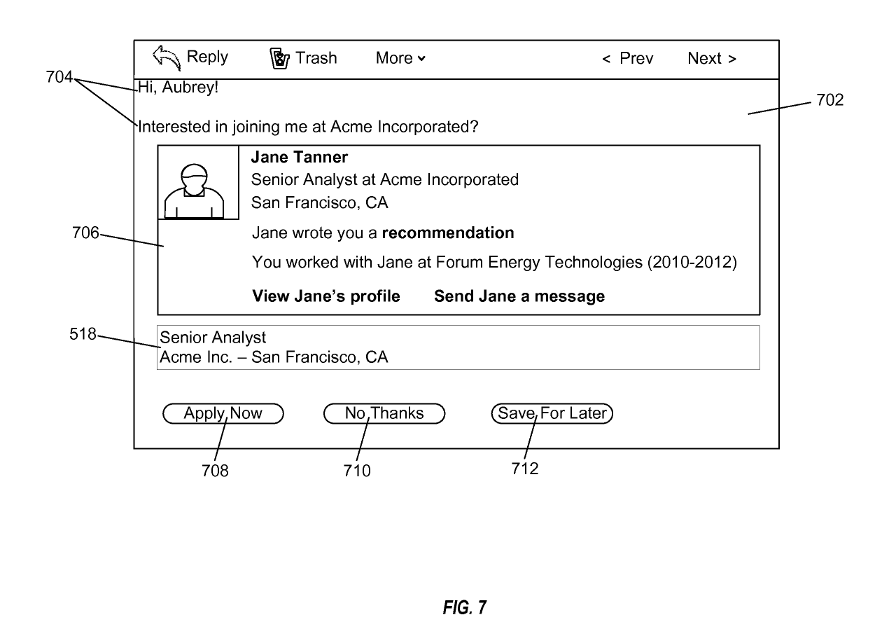

If the selected company connection selects the control corresponding to the response, “Yes, and I will contact (the selected candidate)” 604, a job application invitation (as illustrated in FIG. 7, for example) inviting the selected candidate to apply for the job is sent from the selected company connection to the selected candidate. If the selected company connection selects the control corresponding to the response, “Yes, but you contact (the selected candidate)” 606, the employment recruiter is notified of this response, and may then contact the selected candidate directly. If the selected company connection selects the control corresponding to the response, “Not Now” 608, the employment recruiter is notified of this response.

In some embodiments, when the selected company connection selects a control corresponding to the response, “Yes, and I will contact (the selected candidate)” 604, a job application invitation dialog is presented to the selected company connection prior to the invitation to apply for the job being sent to the selected candidate. The job application invitation dialog is similar to the referral request dialog 500 in that the job application invitation dialog allows the selected company connection to customize the job application invitation prior to sending the job application invitation to the selected candidate.

FIG. 7 illustrates a job application invitation 700 received by a selected candidate, according to an embodiment. The job application invitation 700 is sent from a selected company connection, and invites the selected candidate to apply for the job referenced by the selected job posting link 518. The job application invitation 700 may include one or more personal statements 704.

The job application invitation 700 may include a selected company connection profile 706 for the selected company connection. A selected company connection profile 706 for the selected company connection may be similar to the company connection profile 404 for the selected company connection; however, the contents of the selected company connection profile 706 are from the perspective of the selected candidate. For example, as illustrated in FIG. 7, the selected company connection profile 706 is for the selected company connection “Jane Tanner,” and the relationship statements in the selected company connection profile 706 are from the perspective of the selected candidate “Aubrey Graham.” The selected company connection profile 706 may include a link to view the profile of the selected company connection or to send the selected company connection a message. The selected company connection profile 706 may serve to remind the selected candidate of the selected company connection or of how the selected company connection is related to the selected candidate.

The job application invitation 700 may include several options for the selected candidate to respond to the job application invitation 700. The job application invitation 700 may contain three selectable controls corresponding to the responses, “Apply Now” 708, “No Thanks” 710, and “Save For Later” 712. If the selected candidate selects the control corresponding to the response, “Apply Now” 708, the selected candidate is redirected to the job posting for the open job, where the selected candidate may complete and submit a job application for the open job. If the selected candidate selects the control corresponding to the response, “No Thanks” 710, the job application invitation 700 is hidden or removed from the display of the selected candidate. If the selected candidate selects the control corresponding to the response, “Save For Later” 712, the job application invitation 700 is stored for future access by the selected candidate, and is hidden or removed from the display of the selected candidate. In an embodiment, the employment recruiter is notified regardless of the selected response.

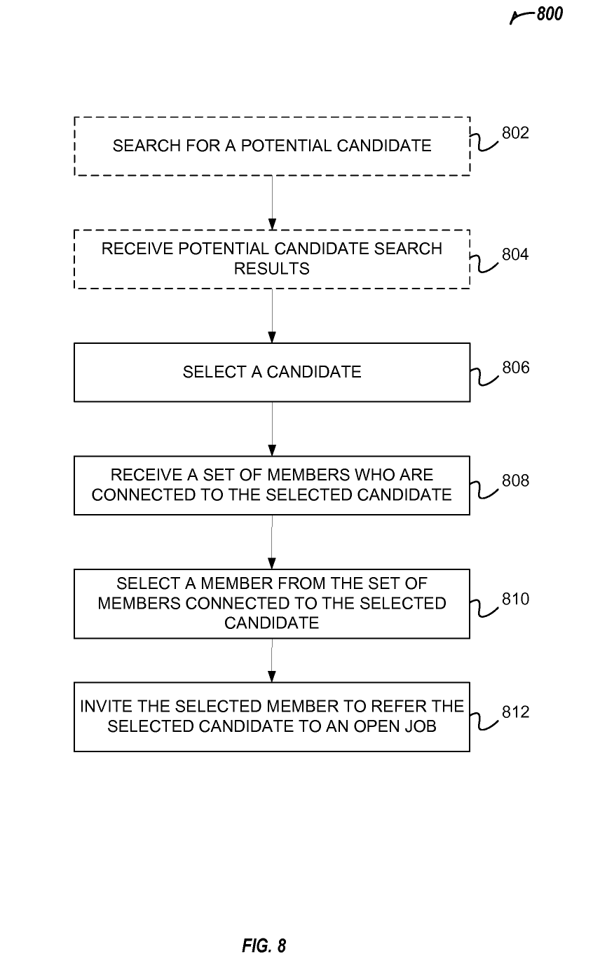

FIG. 8 is a flow diagram illustrating a method 800 performed by a user (e.g., an employment recruiter) to initiate a referral of a selected candidate to a job posting by leveraging a member connection of the selected candidate, according to an embodiment.

Optionally, the user searches for a potential candidate on the online social networking service (operation 802). The search may be performed using a search interface such as those illustrated in FIGS. 2 and 3.

Optionally, the user receives results from a search for potential candidates (operation 804).

The user selects a candidate (operation 806), for example as illustrated in FIG. 4 and described in the accompanying paragraphs.

A set of members who are connected to the selected candidate are displayed to the user (operation 808), for example as illustrated in FIG. 4 and described in the accompanying paragraphs.

The user selects a member from the set of members connected to the selected candidate (operation 810), for example as illustrated in FIGS. 4 and 5 and described in the accompanying paragraphs.

The user invites the selected member to refer the selected candidate to an open job (operation 812), for example as illustrated in FIGS. 5 and 6 and described in the accompanying paragraphs.

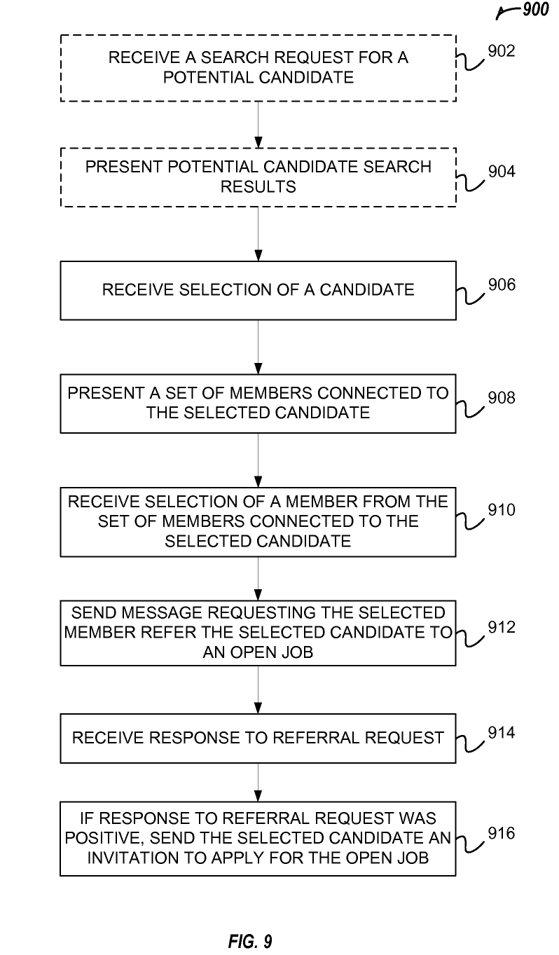

FIG. 9 is a flow diagram illustrating a method 900 performed by an interface for an online social networking service that facilitates recruiter-initiated employment referrals leveraging member connections, according to an embodiment.

Optionally, the interface receives a search request for a potential candidate (operation 902). The search request may include one or more search criteria, such as those illustrated in FIGS. 2 and 3.

Optionally, the interface presents results of the search for a potential candidate (operation 904).

The interface receives a selection of a candidate (operation 906), for example as illustrated in FIG. 4 and described in the accompanying paragraphs.

The interface presents a set of members connected to the selected candidate (operation 908), for example as illustrated in FIG. 4 and described in the accompanying paragraphs.

The interface receives a selection of a member from the set of members connected to the selected candidate (operation 910), for example as illustrated in FIGS. 4 and 5 and described in the accompanying paragraphs.

The interface causes the online social networking service to send a message requesting the selected member refer the selected candidate to an open job (operation 912), for example as illustrated in FIG. 6 and described in the accompanying paragraphs.

The interface receives a response to the referral request (operation 914), for example as illustrated in FIG. 6 and described in the accompanying paragraphs.

If the response to the referral request was positive, the interface causes the online social networking service to send the selected candidate an invitation to apply for the open job (operation 916), for example as illustrated in FIG. 7 and described in the accompanying paragraphs.

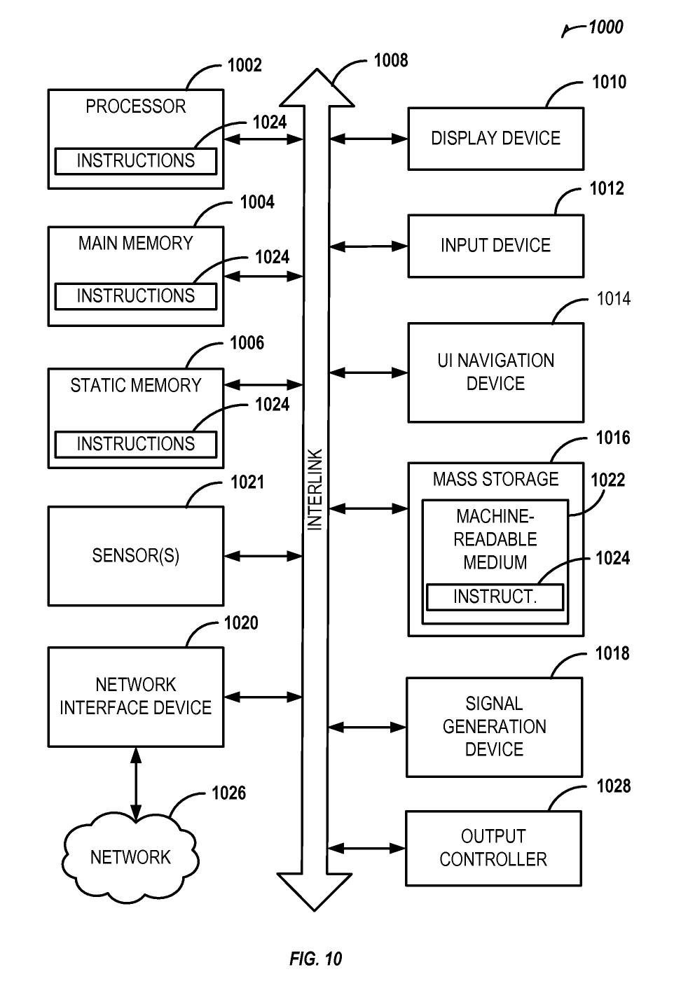

FIG. 10 is a block diagram illustrating an example of a machine 1000, upon which any one or more example embodiments may be implemented. In alternative embodiments, the machine 1000 may operate as a standalone device or may be connected (e.g., networked) to other machines. In a networked deployment, the machine 1000 may operate in the capacity of a server machine, a client machine, or both in a client-server network environment. In an example, the machine 1000 may act as a peer machine in a peer-to-peer (P2P) (or other distributed) network environment. The machine 1000 may implement or include any portion of the social network service from FIG. 1, and may be a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, although only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations, etc.

Examples, as described herein, may include, or may operate by, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 1000 may include a hardware processor 1002 (e.g., a central processing unit (CPU), a graphics processing unit (GPU), a hardware processor core, or any combination thereof), a main memory 1004 and a static memory 1006, some or all of which may communicate with each other via an interlink (e.g., bus) 1008. The machine 1000 may further include a display unit 1010, an alphanumeric input device 1012 (e.g., a keyboard), and a user interface (UI) navigation device 1014 (e.g., a mouse). In an example, the display unit 1010, input device 1012 and UI navigation device 1014 may be a touch screen display. The machine 1000 may additionally include a storage device (e.g., drive unit) 1016, a signal generation device 1018 (e.g., a speaker), a network interface device 1020, and one or more sensors 1021, such as a global positioning system (GPS) sensor, compass, accelerometer, or other sensor. The machine 1000 may include an output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.)

The storage device 1016 may include a machine-readable medium 1022 on which is stored one or more sets of data structures or instructions 1024 (e.g., software) embodying or utilized by any one or more of the techniques or functions described herein. The instructions 1024 may also reside, completely or at least partially, within the main memory 1004, within static memory 1006, or within the hardware processor 1002 during execution thereof by the machine 1000. In an example, one or any combination of the hardware processor 1002, the main memory 1004, the static memory 1006, or the storage device 1016 may constitute machine-readable media.

Although the machine-readable medium 1022 is illustrated as a single medium, the term “machine-readable medium” may include a single medium or multiple media (e.g., a centralized or distributed database, and/or associated caches and servers) configured to store the one or more instructions 1024.

The term “machine-readable medium” may include any medium that is capable of storing, encoding, or carrying instructions for execution by the machine 1000 and that cause the machine 1000 to perform any one or more of the techniques of the present disclosure, or that is capable of storing, encoding or carrying data structures used by or associated with such instructions. Non-limiting machine-readable medium examples may include solid-state memories, and optical and magnetic media. Accordingly, machine-readable media are not transitory propagating signals. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks.

The instructions 1024 may further be transmitted or received over a communications network 1026 using a transmission medium via the network interface device 1020 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMAX®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 1020 may include one or more physical jacks (e.g., Ethernet, coaxial, or phone jacks) or one or more antennas to connect to the communications network 1026. In an example, the network interface device 1020 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1000, and includes digital or analog communications signals or other intangible medium to facilitate communication of such software.

### ADDITIONAL NOTES & EXAMPLE EMBODIMENTS

Example 1 includes subject matter (such as a method, means for performing acts, machine readable medium including instructions that when performed by a machine cause the machine to performs acts, or an apparatus to perform) comprising: receiving data corresponding to a selection of a profile of a candidate who is a member of a social networking service, the candidate desired by a recruiter to apply for an open job having a job posting on the social networking service; presenting to the recruiter a set of member profiles, each member profile in the set belonging to a respective member having a respective member profile connected within the social networking service to the member profile of the candidate; receiving data corresponding to a selection of a member profile within the set of member profiles; presenting to the recruiter a message composition dialog including content modifiable by the recruiter; receiving data corresponding to content submitted by the recruiter via the message composition dialog; and presenting, to the member associated with the selected member profile and based on the submitted content, a message requesting whether the selected member would refer the candidate for the open job.

In Example 2, the subject matter of Example 1 may include, wherein the message requesting whether the selected member would refer the candidate for the open job includes information about the open job.

In Example 3, the subject matter of any one of Examples 1 to 2 may include, wherein the message requesting whether the selected member would refer the candidate for the open job includes a set of selectable user interface elements, each user interface element in the set corresponding to one answer from a group 1) Yes, and the selected member will contact the candidate, 2) Yes, but the recruiter should contact the candidate, and 3) No.

In Example 4, the subject matter of any one of Examples 1 to 3 may include, receiving a response corresponding to the selectable user interface element selected by the selected member.

In Example 5, the subject matter of any one of Examples 1 to 4 may include, upon the response corresponding to the selected user interface element “Yes, and the selected member will contact the candidate”, presenting the selected member with a second message composition dialog including content modifiable by the selected member; receiving data corresponding to content submitted by the selected member via the second message composition dialog; and presenting, to the candidate and based on the submitted content, a message requesting whether the candidate would like to apply for the open job.

In Example 6, the subject matter of any one of Examples 1 to 5 may include, upon the response corresponding to the selected user interface element “Yes, the recruiter should contact the candidate”, presenting the recruiter with a second message composition dialog including content modifiable by the recruiter; receiving data corresponding to content submitted by the recruiter via the second message composition dialog; and presenting, to the candidate and based on the submitted content, a message requesting whether the candidate would like to apply for the open job.

In Example 7, the subject matter of any one of Examples 1 to 6 may include, presenting, to the recruiter prior to receiving the data corresponding to a selection of a candidate profile, data corresponding to a set of candidate profiles, each profile in the set corresponding to a selectable candidate and based on criteria submitted by recruiter.

In Example 8, the subject matter of any one of Examples 1 to 7 may include, wherein the open job belongs to an employer; and wherein the data corresponding to the set of profiles includes summary data to be presented to the recruiter, the summary data including at least one summary data type corresponding to one of: the number of profiles in the set; the collective number of connections, for all of the profiles in the set of profiles, to at least one member profile of a member employed by the employer; a number of interested candidates, each interested candidate having a first respective profile in the set of profiles, each first respective profile indicating the respective candidate is interested in a new job; a number of past applicants, each past applicant having a second respective profile in the set of profiles, each second respective profile indicating the respective past applicant has previously applied for the open job; and a number of internal candidates, each internal candidate having a third respective profile in the set of profiles, each third respective profile indicating the respective internal candidate is currently employed by the employer.

In Example 9, the subject matter of any one of Examples 1 to 8 may include, wherein a candidate profile from the set of candidate profiles is to be presented with at least one selectable user interface element corresponding to at least one summary data type applicable to the candidate profile.

In Example 10, the subject matter of any one of Examples 1 to 9 may include, wherein the data corresponding to the set of profiles includes a set of selectable user interface elements to be presented to the recruiter, each selectable user interface element in the set corresponding to one summary data type.

In Example 11, the subject matter of any one of Examples 1 to 10 may include, receiving a response corresponding to the selectable user interface element selected by the recruiter; generating a second set of profiles of selectable candidates, the second set corresponding to the selectable user interface element selected by the recruiter; and presenting to the recruiter the generated second set of profiles.

Example 12 includes subject matter (such as a CRM) comprising: receiving data corresponding to a selection of a profile of a candidate who is a member of a social networking service, the candidate desired by a recruiter to apply for an open job having a job posting on the social networking service; presenting to the recruiter a set of member profiles, each member profile in the set belonging to a respective member having a respective member profile connected within the social networking service to the member profile of the candidate; receiving data corresponding to a selection of a member profile within the set of member profiles; presenting to the recruiter a message composition dialog including content modifiable by the recruiter; receiving data corresponding to content submitted by the recruiter via the message composition dialog; and presenting, to the member associated with the selected member profile and based on the submitted content, a message requesting whether the selected member would refer the candidate for the open job.

In Example 13, the subject matter of Example 12 may include, wherein the message requesting whether the selected member would refer the candidate for the open job includes information about the open job.

In Example 14, the subject matter of any one of Examples 12 to 13 may include, wherein the message requesting whether the selected member would refer the candidate for the open job includes a set of selectable user interface elements, each user interface element in the set corresponding to one answer from a group 1) Yes, and the selected member will contact the candidate, 2) Yes, but the recruiter should contact the candidate, and 3) No.

In Example 15, the subject matter of any one of Examples 12 to 14 may include, wherein the machine-readable medium includes further machine-readable instructions which, when executed by the machine, cause the machine to perform operations receiving a response corresponding to the selectable user interface element selected by the selected member.

In Example 16, the subject matter of any one of Examples 12 to 15 may include, wherein the machine-readable medium includes further machine-readable instructions which, when executed by the machine, cause the machine to perform operations upon the response corresponding to the selected user interface element “Yes, and the selected member will contact the candidate”, presenting the selected member with a second message composition dialog including content modifiable by the selected member; receiving data corresponding to content submitted by the selected member via the second message composition dialog; and presenting, to the candidate and based on the submitted content, a message requesting whether the candidate would like to apply for the open job.

In Example 17, the subject matter of any one of Examples 12 to 16 may include, wherein the machine-readable medium includes further machine-readable instructions which, when executed by the machine, cause the machine to perform operations upon the response corresponding to the selected user interface element “Yes, the recruiter should contact the candidate”, presenting the recruiter with a second message composition dialog including content modifiable by the recruiter; receiving data corresponding to content submitted by the recruiter via the second message composition dialog; and presenting, to the candidate and based on the submitted content, a message requesting whether the candidate would like to apply for the open job.

In Example 18, the subject matter of any one of Examples 12 to 17 may include, wherein the machine-readable medium includes further machine-readable instructions which, when executed by the machine, cause the machine to perform operations presenting, to the recruiter prior to receiving the data corresponding to a selection of a candidate profile, data corresponding to a set of candidate profiles, each profile in the set corresponding to a selectable candidate and based on criteria submitted by recruiter.

In Example 19, the subject matter of any one of Examples 12 to 18 may include, wherein the open job belongs to an employer; and wherein the data corresponding to the set of profiles includes summary data to be presented to the recruiter, the summary data including at least one summary data type corresponding to one of: the number of profiles in the set; the collective number of connections, for all of the profiles in the set of profiles, to at least one member profile of a member employed by the employer; a number of interested candidates, each interested candidate having a first respective profile in the set of profiles, each first respective profile indicating the respective candidate is interested in a new job; a number of past applicants, each past applicant having a second respective profile in the set of profiles, each second respective profile indicating the respective past applicant has previously applied for the open job; and a number of internal candidates, each internal candidate having a third respective profile in the set of profiles, each third respective profile indicating the respective internal candidate is currently employed by the employer.

In Example 20, the subject matter of any one of Examples 12 to 19 may include, wherein a candidate profile from the set of candidate profiles is to be presented with at least one selectable user interface element corresponding to at least one summary data type applicable to the candidate profile.

In Example 21, the subject matter of any one of Examples 12 to 20 may include, wherein the data corresponding to the set of profiles includes a set of selectable user interface elements to be presented to the recruiter, each selectable user interface element in the set corresponding to one summary data type.

In Example 22, the subject matter of any one of Examples 12 to 21 may include, wherein the machine-readable medium includes further machine-readable instructions which, when executed by the machine, cause the machine to perform operations receiving a response corresponding to the selectable user interface element selected by the recruiter; generating a second set of profiles of selectable candidates, the second set corresponding to the selectable user interface element selected by the recruiter; and presenting to the recruiter the generated second set of profiles.

Example 23 includes subject matter (such as a device, apparatus, or machine) comprising: a machine-readable medium including machine-readable instructions which, when executed by a processor, cause the social networking system to perform operations comprising: receiving data corresponding to a selection of a profile of a candidate who is a member of a social networking service, the candidate desired by a recruiter to apply for an open job having a job posting on the social networking service; presenting to the recruiter a set of member profiles, each member profile in the set belonging to a respective member having a respective member profile connected within the social networking service to the member profile of the candidate; receiving data corresponding to a selection of a member profile within the set of member profiles; presenting to the recruiter a message composition dialog including content modifiable by the recruiter; receiving data corresponding to content submitted by the recruiter via the message composition dialog; and presenting, to the member associated with the selected member profile and based on the submitted content, a message requesting whether the selected member would refer the candidate for the open job.

In Example 24, the subject matter of Example 23 may include, wherein the message requesting whether the selected member would refer the candidate for the open job includes information about the open job.

In Example 25, the subject matter of any one of Examples 23 to 24 may include, wherein the message requesting whether the selected member would refer the candidate for the open job includes a set of selectable user interface elements, each user interface element in the set corresponding to one answer from a group 1) Yes, and the selected member will contact the candidate, 2) Yes, but the recruiter should contact the candidate, and 3) No.

In Example 26, the subject matter of any one of Examples 23 to 25 may include, wherein the machine-readable medium includes further machine-readable instructions which, when executed by the processor, cause the social networking system to perform operations receiving a response corresponding to the selectable user interface element selected by the selected member.

In Example 27, the subject matter of any one of Examples 23 to 26 may include, wherein the machine-readable medium includes further machine-readable instructions which, when executed by the processor, cause the social networking system to perform operations upon the response corresponding to the selected user interface element “Yes, and the selected member will contact the candidate”, presenting the selected member with a second message composition dialog including content modifiable by the selected member; receiving data corresponding to content submitted by the selected member via the second message composition dialog; and presenting, to the candidate and based on the submitted content, a message requesting whether the candidate would like to apply for the open job.

In Example 28, the subject matter of any one of Examples 23 to 27 may include, wherein the machine-readable medium includes further machine-readable instructions which, when executed by the processor, cause the social networking system to perform operations upon the response corresponding to the selected user interface element “Yes, the recruiter should contact the candidate”, presenting the recruiter with a second message composition dialog including content modifiable by the recruiter; receiving data corresponding to content submitted by the recruiter via the second message composition dialog; and presenting, to the candidate and based on the submitted content, a message requesting whether the candidate would like to apply for the open job.

In Example 29, the subject matter of any one of Examples 23 to 28 may include, wherein the machine-readable medium includes further machine-readable instructions which, when executed by the processor, cause the social networking system to perform operations presenting, to the recruiter prior to receiving the data corresponding to a selection of a candidate profile, data corresponding to a set of candidate profiles, each profile in the set corresponding to a selectable candidate and based on criteria submitted by recruiter.

In Example 30, the subject matter of any one of Examples 23 to 29 may include, wherein the open job belongs to an employer; and wherein the data corresponding to the set of profiles includes summary data to be presented to the recruiter, the summary data including at least one summary data type corresponding to one of: the number of profiles in the set; the collective number of connections, for all of the profiles in the set of profiles, to at least one member profile of a member employed by the employer; a number of interested candidates, each interested candidate having a first respective profile in the set of profiles, each first respective profile indicating the respective candidate is interested in a new job; a number of past applicants, each past applicant having a second respective profile in the set of profiles, each second respective profile indicating the respective past applicant has previously applied for the open job; and a number of internal candidates, each internal candidate having a third respective profile in the set of profiles, each third respective profile indicating the respective internal candidate is currently employed by the employer.

In Example 31, the subject matter of any one of Examples 23 to 30 may include, wherein a candidate profile from the set of candidate profiles is to be presented with at least one selectable user interface element corresponding to at least one summary data type applicable to the candidate profile.

In Example 32, the subject matter of any one of Examples 23 to 31 may include, wherein the data corresponding to the set of profiles includes a set of selectable user interface elements to be presented to the recruiter, each selectable user interface element in the set corresponding to one summary data type.

In Example 33, the subject matter of any one of Examples 23 to 32 may include, wherein the machine-readable medium includes further machine-readable instructions which, when executed by the processor, cause the social networking system to perform operations receiving a response corresponding to the selectable user interface element selected by the recruiter; generating a second set of profiles of selectable candidates, the second set corresponding to the selectable user interface element selected by the recruiter; and presenting to the recruiter the generated second set of profiles.

Conventional terms in the fields of computer networking and computer systems have been used herein. The terms are known in the art and are provided only as a non-limiting example for convenience purposes. Accordingly, the interpretation of the corresponding terms in the claims, unless stated otherwise, is not limited to any particular definition.

Although specific embodiments have been illustrated and described herein, it will be appreciated by those of ordinary skill in the art that any arrangement that is calculated to achieve the same purpose may be substituted for the specific embodiments shown. Many adaptations will be apparent to those of ordinary skill in the art. Accordingly, this application is intended to cover any adaptations or variations.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. Moreover, in the following claims, the terms “first,” “second,” and “third,” etc. are used merely as labels, and are not intended to impose numerical requirements on their objects.

In this Detailed Description, various features may have been grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments may be combined with each other in various combinations or permutations. The scope of the embodiments should be determined with reference to the appended claims, along with the full scope of equivalents to which such claims are entitled.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to allow the reader to quickly ascertain the nature of the technical disclosure and is submitted with the understanding that it will not be used to interpret or limit the scope or meaning of the claims.

1. A method performed by a social networking service to facilitate a recruiter-initiated referral of a member of the social networking service, the method comprising:
receiving data corresponding to a selection of a profile of a candidate who is a member of a social networking service, the candidate desired by a recruiter to apply for an open job having a job posting on the social networking service;
presenting to the recruiter a set of member profiles, each member profile in the set belonging to a respective member having a respective member profile connected within the social networking service to the member profile of the candidate;
receiving data corresponding to a selection of a member profile within the set of member profiles;
presenting to the recruiter, within an interface of the social networking service, a message composition dialog including content modifiable by the recruiter including composing a message to the member associated with the selected member profile;
receiving, by the social networking service, data corresponding to content submitted by the recruiter via the message composition dialog; and
presenting, to the member associated with the selected member profile and based on the submitted content, a message within the social networking service, the message requesting whether the selected member would refer the candidate for the open job.

2. The method of claim 1, wherein the message requesting whether the selected member would refer the candidate for the open job includes information about the open job.

3. The method of claim 1, wherein the message requesting whether the selected member would refer the candidate for the open job includes a set of selectable user interface elements comprising:
a first user interface element corresponding to a first answer specifying Yes, and the selected member will contact the candidate, a second user interface element corresponding to a second answer specifying Yes, but the recruiter should contact the candidate, and a third user interface element corresponding to a third answer specifying No.

4. The method of claim 3, further comprising:
receiving a response corresponding to the selectable user interface element selected by the selected member.

5. The method of claim 4, further comprising:
upon the response corresponding to the selected user interface element corresponding to the first answer specifying Yes, and the selected member will contact the candidate, presenting the selected member with a second message composition dialog including content modifiable by the selected member;
receiving data corresponding to content submitted by the selected member via the second message composition dialog; and
presenting, to the candidate and based on the submitted content, a message requesting whether the candidate would like to apply for the open job.

6. The method of claim 4, further comprising:
upon the response corresponding to the selected user interface element corresponding to the second answer specifying Yes, the recruiter should contact the candidate, presenting the recruiter with a second message composition dialog including content modifiable by the recruiter;
receiving data corresponding to content submitted by the recruiter via the second message composition dialog; and
presenting, to the candidate and based on the submitted content, a message requesting whether the candidate would like to apply for the open job.

7. The method of claim 1, further comprising:
presenting, to the recruiter prior to receiving the data corresponding to a selection of a candidate profile, data corresponding to a set of candidate profiles, each profile in the set corresponding to a selectable candidate and based on criteria submitted by the recruiter.

8. The method of claim 7, wherein the open job belongs to an employer; and
wherein the data corresponding to the set of profiles includes summary data to be presented to the recruiter, the summary data including at least one summary data type corresponding to one of:
the number of profiles in the set;
the collective number of connections, for all of the profiles in the set of profiles, to at least one member profile of a member employed by the employer;
a number of interested candidates, each interested candidate having a first respective profile in the set of profiles, each first respective profile indicating the respective candidate is interested in a new job;
a number of past applicants, each past applicant having a second respective profile in the set of profiles, each second respective profile indicating the respective past applicant has previously applied for the open job; and
a number of internal candidates, each internal candidate having a third respective profile in the set of profiles, each third respective profile indicating the respective internal candidate is currently employed by the employer.

9. The method of claim 8, wherein a candidate profile from the set of candidate profiles is to be presented with at least one selectable user interface element corresponding to at least one summary data type applicable to the candidate profile.

10. The method of claim 8, wherein the data corresponding to the set of profiles includes a set of selectable user interface elements to be presented to the recruiter, each selectable user interface element in the set corresponding to one summary data type.

11. The method of claim 10, further comprising:
receiving a response corresponding to the selectable user interface element selected by the recruiter;
generating a second set of profiles of selectable candidates, the second set corresponding to the selectable user interface element selected by the recruiter; and
presenting to the recruiter the generated second set of profiles.

12. A non-transitory machine-readable medium including machine-readable instructions which, when executed by a machine, cause the machine to perform operations comprising:
receiving data corresponding to a selection of a profile of a candidate who is a member of a social networking service, the candidate desired by a recruiter to apply for an open job having a job posting on the social networking service;
presenting to the recruiter a set of member profiles, each member profile in the set belonging to a respective member having a respective member profile connected within the social networking service to the member profile of the candidate;
receiving data corresponding to a selection of a member profile within the set of member profiles;
presenting to the recruiter, within an interface of the social networking service, a message composition dialog including content modifiable by the recruiter including composing a message to the member associated with the selected member profile;
receiving, by the social networking service, data corresponding to content submitted by the recruiter via the message composition dialog; and
presenting, to the member associated with the selected member profile and based on the submitted content, a message within the social networking service, the message requesting whether the selected member would refer the candidate for the open job.

13. The non-transitory machine-readable medium of claim 12, wherein the message requesting whether the selected member would refer the candidate for the open job includes information about the open job.

14. The non-transitory machine-readable medium of claim 12, wherein the message requesting whether the selected member would refer the candidate for the open job includes a set of selectable user interface elements comprising:
a first user interface element corresponding to a first answer specifying Yes, and the selected member will contact the candidate, a second user interface element corresponding to a second answer specifying Yes, but the recruiter should contact the candidate, and a third user interface element corresponding to a third answer specifying No.

15. The non-transitory machine-readable medium of claim 14, wherein the machine-readable medium includes further machine-readable instructions which, when executed by the machine, cause the machine to perform operations further comprising:
receiving a response corresponding to the selectable user interface element selected by the selected member.

16. The non-transitory machine-readable medium of claim 15, wherein the machine-readable medium includes further machine-readable instructions which, when executed by the machine, cause the machine to perform operations further comprising:
upon the response corresponding to the selected user interface element corresponding to the first answer specifying Yes, and the selected member will contact the candidate, presenting the selected member with a second message composition dialog including content modifiable by the selected member;
receiving data corresponding to content submitted by the selected member via the second message composition dialog; and
presenting, to the candidate and based on the submitted content, a message requesting whether the candidate would like to apply for the open job.

17. The non-transitory machine-readable medium of claim 15, wherein the machine-readable medium includes further machine-readable instructions which, when executed by the machine, cause the machine to perform operations further comprising:
upon the response corresponding to the selected user interface element corresponding to the second answer specifying Yes, the recruiter should contact the candidate, presenting the recruiter with a second message composition dialog including content modifiable by the recruiter;
receiving data corresponding to content submitted by the recruiter via the second message composition dialog; and
presenting, to the candidate and based on the submitted content, a message requesting whether the candidate would like to apply for the open job.

18. The non-transitory machine-readable medium of claim 12, wherein the machine-readable medium includes further machine-readable instructions which, when executed by the machine, cause the machine to perform operations further comprising:
presenting, to the recruiter prior to receiving the data corresponding to a selection of a candidate profile, data corresponding to a set of candidate profiles, each profile in the set corresponding to a selectable candidate and based on criteria submitted by the recruiter.

19. The non-transitory machine-readable medium of claim 18, wherein the open job belongs to an employer; and
wherein the data corresponding to the set of profiles includes summary data to be presented to the recruiter, the summary data including at least one summary data type corresponding to one of:
the number of profiles in the set;
the collective number of connections, for all of the profiles in the set of profiles, to a east one member profile of a member employed by the employer;
a number of interested candidates, each interested candidate having a first respective profile in the set of profiles, each first respective profile indicating the respective candidate is interested in a new job;
a number of past applicants, each past applicant having a second respective profile in the set of profiles, each second respective profile indicating the respective past applicant has previously applied for the open job; and
a number of internal candidates, each internal candidate having a third respective profile in the set of profiles, each third respective profile indicating the respective internal candidate is currently employed by the employer.

20. The non-transitory machine-readable medium of claim 19, wherein a candidate profile from the set of candidate profiles is to be presented with at least one selectable user interface element corresponding to at least one summary data type applicable to the candidate profile.

21. The non-transitory machine-readable medium of claim 19, wherein the data corresponding to the set of profiles includes a set of selectable user interface elements to be presented to the recruiter, each selectable user interface element in the set corresponding to one summary data type.

22. The non-transitory machine-readable medium of claim 21, wherein the machine-readable medium includes further machine-readable instructions which, when executed by the machine, cause the machine to perform operations further comprising:
receiving a response corresponding to the selectable user interface element selected by the recruiter;
generating a second set of profiles of selectable candidates, the second set corresponding to the selectable user interface element selected by the recruiter; and
presenting to the recruiter the generated second set of profiles.

23. A social networking system comprising:
a machine-readable medium including machine-readable instructions which, when executed by a processor, cause the system to perform operations comprising:
receiving data corresponding to a selection of a profile of a candidate who is a member of a social networking service, the candidate desired by a recruiter to apply for an open job having a job posting on the social networking service;
presenting to the recruiter a set of member profiles, each member profile in the set belonging to a respective member having a respective member profile connected within the social networking service to the member profile of the candidate;
receiving data corresponding to a selection of a member profile within the set of member profiles;
presenting to the recruiter, within an interface of the social networking service, a message composition dialog including content modifiable by the recruiter including composing a message to the member associated with the selected member profile;
receiving, by the social networking service, data corresponding to content submitted by the recruiter via the message composition dialog; and
presenting, to the member associated with the selected member profile and based on the submitted content, a message within the social networking service, the message requesting whether the selected member would refer the candidate for the open job.

24. The social networking system of claim 23, wherein the message requesting whether the selected member would refer the candidate for the open job includes information about the open job.

25. The social networking system of claim 23, wherein the message requesting whether the selected member would refer the candidate for the open job includes a set of selectable user interface elements comprising:
a first user interface element corresponding to a first answer specifying Yes, and the selected member will contact the candidate, a second user interface element corresponding to a second answer specifying Yes, but the recruiter should contact the candidate, and a third user interface element corresponding to a third answer specifying No.
